(19) United States
(12) Patent Application Publication
(10) Pub. No.: US 2017/0320677 A1
(43) Pub. Date: Nov. 9, 2017

(54) METHOD FOR COMBINING MATERIALS TO BE PACKAGED, AND DEVICE FOR CONVEYING MATERIALS TO BE PACKAGED

(71) Applicant: SIEMENS AKTIENGESELLSCHAFT, MUENCHEN (DE)

(72) Inventor: ROLF WIEHLER, ALLENSBACH (DE)

(21) Appl. No.: 15/531,053

(22) PCT Filed: Aug. 31, 2015
(86) PCT No.: PCT/EP2015/069859

§ 371 Date: May 26, 2017

(30) Foreign Application Priority Data
Nov. 26, 2014 (DE) 10 2014 224 147.2

(51) Int. Cl. B65G 47/71

(52) U.S. Cl. CPC B65G 47/715

(57) ABSTRACT

A method for combining multiple separate streams of packaged materials into a main stream is provided, in which each of the streams of packaged materials is conveyed on a feed conveyor, is combined with the main stream in the region of a feed opening of the feed conveyor and further transported on a main conveyor in the main stream and in which at least one lateral wall laterally delimits the main stream. In order to combine multiple separate streams of packaged materials into the main stream despite a narrowing of the conveyor width to counteract jamming, packaged materials from the main stream in the region between two feed openings of two feed conveyors are guided towards the lateral wall and then along the lateral wall, as a result of an alignment of the main conveyor relative to the lateral wall. A device for conveying packaged materials is also provided.

The invention relates to a method for combining multiple separate streams of packaged materials into a main stream, in which each of the streams of packaged materials is conveyed on a feed conveyor, is combined with the main stream in the region of a feed opening of the feed conveyor and is further transported in the main stream on a main conveyor, wherein at least one lateral wall laterally delimits the main stream.

In large parcel centers, logistics centers or goods transshipment centers and also in baggage conveyance applications, large quantities of inhomogeneous and mutually unordered parcels, binders, items of baggage and the like are conveyed in streams of goods to be transported. As not all goods to be transported have the same origin or the same destination, streams of goods to be transported from different sources are combined in a main stream and the main stream is later separated once more for further transport to different destinations. As the goods to be transported can be individual and each have their own destination and generally have packaging, such as parcel packaging, goods packaging, a suitcase or the like, subsequent text refers to packaged materials, in order to differentiate it from filling material or bulk material.

During the combination of streams of packaged materials, jams may occur, in which a conveyor path becomes blocked and pushes subsequent packaged materials into the jam. The forces taking effect here can result in damage to the packaged materials. Such a jam can be avoided if the width of the main conveyor is at least as great as the sum of all feed conveyors whose streams of packaged materials are combined in the main stream on the main conveyor. Here, however, a very wide main conveyor would be required, which would be disadvantageous in terms of space requirements, cost and also in the case of the subsequent separation of the main stream into multiple destination streams.

It is a task of the present invention to specify a method for combining multiple separate streams of packaged materials into a main stream, with which jamming can be counteracted despite a narrowing of the conveyor width.

This problem is solved by means of a method cited in the preamble, in which according to the invention, as a result of an alignment of the main conveyor relative to the lateral wall, packaged materials from the main stream in the region between two feed openings of two feed conveyors are guided up to and then along it. The arrangement of the packaged materials on the main conveyor can thus be compressed towards the lateral wall, so that space for a stream of packaged materials subsequently occurring arises on the side of the main conveyor facing away from the lateral wall.

Expediently, as a result of an alignment of the main conveyor relative to the lateral wall, the packaged materials from the main stream in the region of a feed opening of a feed conveyor too are guided up to and along it, in particular continuously from one feed opening to the next one downstream.

Packaged materials or a package can be taken to mean a packaged object, such as a parcel, a binder or packaged goods, an item of baggage, or the like. In contrast to bulk material or filling material, packaged materials are a single object with packaging, enclosing single or multiple items. The packaged materials can be a postal or courier consignment, a rectangular object, a parcel, in particular a postal or courier parcel, a binder, packaged individual goods, an item of baggage and/or the like. The main stream is a stream of packaged materials, in which packaged materials, in particular all packaged materials, can be combined from multiple streams of packaged materials from the feed conveyor.

The streams of packaged materials are expediently bulk streams, that is streams in which the individual packages are transported in a mutually unordered manner. Both the alignment of the packages relative to each other and the density of packages per meter can here be irregular, that is may fluctuate by a factor of more than 10. Heaping of the packaged materials when viewed from the side of the stream of packaged materials is possible and entirely customary. The conveyed packaged materials are inhomogeneous in nature and can differ greatly particularly in respect of the weight of the individual items of packaged materials, their surface characteristics and in terms of dimension and shape. The orientation of the packaged materials on the feed conveyors is also inhomogeneous and the density of the stream of packaged materials on a feed conveyor, for example the space occupancy of packaged materials per square meter, in particular per 5 square meters, can fluctuate by a factor of 10 or more. Piled-up packaged materials can also be present in the streams of packaged materials.

The main conveyor and the feed conveyor expediently comprise in each case single or multiple conveyor units, which in each case have a conveyor element, which can be moved in the direction of conveyance by a conveyor drive. The packaged materials lie on the conveyor elements and are moved by them in the corresponding direction of conveyance, that is for example in the feed direction on the feed conveyor or, as the case may be, the main direction of conveyance on the main conveyor. The conveyor width of the main conveyor is advantageously less than the sum of the conveyor widths of the feed conveyors, expediently at least 30% narrower, in particular at least 45% narrower. Here, the conveyor width of the main conveyor is expediently to be determined at its narrowest point. The conveyor widths can here be the maximum widths that the respective stream of packaged materials or the main stream can occupy.

The directions of conveyance relate to the conveying movement of the conveyor elements, wherein the packaged materials can also move somewhat at variance to the corresponding direction of conveyance, for example as a result of colliding with each other or with the lateral wall, slippage, for example on a sloping surface, and the like.

The main direction of conveyance is expediently aligned transversely to the feed direction, that is at an angle between 50° and 110°, preferably between 80° and 100°, wherein 0° specifies parallelism of the main direction of conveyance to the feed direction and 180° antiparallelism. The device for conveying packaged materials can hereby be kept compact even in the case of a multiplicity of feed conveyors. The directions of feed of the feed conveyor are expediently aligned parallel to each other, wherein in particular the feed conveyors themselves are aligned parallel to each other. They can meet at the main conveyor, which is expediently aligned continuously transversely to the feed conveyors alongside all feed conveyors, so that the main direction of conveyance is thus aligned continuously transversely to the directions of feed alongside all feed conveyors. The feed conveyors expediently reach as far as the main conveyor, wherein the directions of feed expediently reach as far as the conveyor element or conveyor elements of the main conveyor, which transport in the main direction of conveyance.

The alignment of the main conveyor, by means of which the packages are guided up to the lateral wall and then in particular along the lateral wall, can be an arrangement of the main direction of conveyance at an in particular acute angle to the lateral wall, so that in the case of a movement in the main direction of conveyance the packaged materials are brought closer to the lateral wall. This alignment can expediently be facilitated or replaced by another alignment, namely an inclination of the main conveyor, or of the conveyor element of the main conveyor, towards the lateral wall, so that sliding of the packaged materials on the conveyor element towards the lateral wall is facilitated by the force of gravity.

In one advantageous embodiment of the invention the main stream on the main conveyor is moved in a main direction of conveyance, which is at an angle to the lateral wall, and the packaged materials from the main stream are guided towards the lateral wall and then along this by the movement in the main direction of conveyance. If the packaged materials are on the lateral wall, then through the movement of the main conveyor in the main direction of conveyance with pressure against the lateral wall, it is conveyed along this, in a direction diverging from the main direction of conveyance by the corresponding angle. The packaged materials can be continuously compressed against the lateral wall and also aligned with the lateral wall, so that the compression can arise particularly completely both by means of the guidance to the lateral wall and by the alignment.

The main direction of conveyance is arranged at an angle to the lateral wall, that is at an angle α≠0° or α≠180° to the lateral wall. An angle between 1° and 20° to the lateral wall, in particular between 2° and 10°, is advantageous. The angle is to be regarded as being in the plane of the conveyor surface of the main conveyor, that is in the case of a horizontal conveyor surface it is an angle is between two horizontal directions and in the case of an inclined conveyor surface, an angle in the corresponding inclined plane.

The lateral wall delimits the lateral movement of the packaged materials in the stream of packaged materials. By means of the lateral deflection of the packaged materials into the main stream by the lateral wall, the stream of packaged materials can be compressed in a targeted and measured manner through the closure of gaps. Rectangular packaged materials lying slantwise to the main direction of conveyance can be aligned parallel to the lateral wall by the lateral wall during the further course of the transport by the main conveyor, as a result of which the utilization and thus the filling level of the available surface of the main conveyor or its conveyor element is further improved. Through the targeted compression and even alignment of the packaged materials in relation to the lateral wall, space is created for one or multiple subsequent downstream inputs from further feed conveyors.

The lateral wall is expediently arranged between two feed openings of two of the feed conveyors and relative to the main stream opposite the feed openings. The arrangement can be such that the packaged materials are propelled by the lateral wall in the direction of the feed opening of the next downstream feed conveyor. In this respect the lateral wall can narrow the main stream towards the feed opening. By means of this narrowing, space for the addition of the further stream of packaged materials from the downstream feed conveyor can be created herefrom on the side of the main conveyor or of the conveyor element facing away from the lateral wall. It is in this respect advantageous, if through the movement of the packaged materials in the main direction of conveyance, space free from packaged materials arises on the side of the main conveyor facing away from the lateral wall for a further stream of packaged materials occurring.

The invention is particularly advantageously applicable in parcel centers for the combination of postal or courier parcels. Each stream of packages can originate from an unloading station, for example a truck unloading station or a roll cage unloading station, for example unloaded by an unloader using a telescopic unloader, so that the packages are conveyed directly or indirectly to the feed conveyor from the telescopic unloader. Depending on the composition of the loaded goods or the activity of the unloader, the stream of packages is very uneven. The meeting of multiple, very heavy streams of packages in the main stream can be also be handled with a minimum of disruption by means of the invention. In this respect it is advantageous if postal or courier consignments in the form of packaged materials, in particular packages, are loaded from a truck unloading station onto an unloading conveyor, in particular a telescopic unloader, which conveys the packages onto the feed conveyor, which in turn feeds the packages into the main stream. The feed conveyor can in this respect be linked in each case with a truck unloading station via the unloading conveyor.

An arrangement of the lateral wall at an angle between 1° and 20° to the main direction of conveyance can be simply realized if a conveyor element runs at least partially beneath the lateral wall, with the lateral wall thus arranged over the conveyor element. A vertical gap can here be present between lateral wall and conveyor element, in order to avoid the conveyor element rubbing on the lateral wall.

In the case of flat goods packed in foil, in particular in the case of packaging in bagged form, it can occur that the foil packaging is drawn in between the moving conveyor element and the lateral wall, as a result of which the consignment is squashed and possibly damaged, for example in that the packaging is torn. In order to prevent this, it is advantageous if the lateral wall is at least partially arranged above a conveyor element of the main conveyor and forms a gap to the conveyor element, which becomes vertically larger downstream. Through the enlargement of the gap the consignment is though still drawn into the gap during its movement downstream. However as this widens vertically, crushing of the foil-packaged goods and their consequent damage can be counteracted. In this respect it is advantageous, if during their conveyance along the lateral wall packaged materials wedge in a gap between a conveyor element of the main conveyor and the lateral wall arranged above this and downstream are drawn into the gap, the gap widens vertically in the downstream direction and frees the packaged materials.

In order to counteract the wedging of flexible packaging between lateral wall and conveyor element, it is additionally advantageous if the lateral wall at an angle to the main direction of conveyance is as short as possible, or as the case may be the angled section of the lateral wall is as short as possible. Wedged consignments are not dragged along over a long distance, as a result of which the danger of damage is reduced. Nevertheless in order to achieve a certain stream density, it is advantageous if the angle between main direction of conveyance and lateral wall is relatively large, that is in the range between 5° and 20°, in particular 10° and 20°.

However an angle of this magnitude entails the danger that the main stream in this conveyor segment becomes too strongly compressed and a conveyor jam hereby occurs. In order to counteract such jamming, it is proposed that the lateral wall is spring-mounted. As a result of the packaged materials pushing against the spring pressure it can thus be moved, in particular pivoted. In this way the angle between the lateral wall and the main direction of conveyance can in particular be reduced, so that the compression is diminished. The already dense and jam-prone main stream pushes—moving the lateral wall outwards—through the narrowing, and jamming is prevented. Expediently after the packaged materials have slid off, the lateral wall springs back into an original position, so that a lighter main stream is guided along the lateral wall in its original position.

In order also to achieve a minimum compression in the case of a movable mounting of the lateral wall, it is advantageous if the lateral wall presses against a stop and in this position describes an angle between 1° and 10° to the main direction of conveyance. Despite the high density of the main stream an area of the conveyor element opposite the lateral wall can be kept free for the introduction of a further stream of packaged materials.

In a further advantageous embodiment of the invention at least one of the feed conveyors has a junction aligned obliquely downwards in the direction of the stream. At this junction the packaged materials can be moved in the direction of the main conveyor by the force of gravity, so that they slide at an angle to the main direction of conveyance, in particular transversely to the main direction of conveyance on the main conveyor in the direction of the lateral wall. In this way the packaged materials from the stream of packaged materials from the feed conveyor can be deflected directly towards the lateral wall, so that the portion of the main stream formed in this way is already compressed towards the lateral wall. The junction can be a chute, on which the packaged materials slide downwards.

In the case of temporarily very dense streams of packaged materials from at least two feed conveyors, the main conveyor can already be so overfilled that insufficient room remains for the feeding of a third, and currently very heavy stream of packaged materials on the main conveyor. In order to prevent jamming and crushing of the packaged materials, it is advantageous if the occupancy of packaged materials on the main conveyor is recorded in the main stream. This can expediently take place with the aid of a sensor, which can be arranged on the main conveyor. The sensor can be an occupancy sensor, which measures a stretch of the main conveyor which is free from packaged materials. By means of a multiplicity of successive measurements of the respective stretch, a free surface area on the main conveyor can be determined.

Advantageously a control unit controls feeding of a stream of packaged materials from a feed conveyor onto the main conveyor depending on a value derived from the stretch. This value can be an area on the main conveyor which is free from packaged goods, which can be used as a control value. The occupancy sensor can be a distance sensor, which measures a stretch between the sensor and the packaged materials on the main conveyor, in particular a laser distance sensor. The sensor is expediently arranged opposite the lateral wall and in particular detects a stretch to the next packaged materials arranged in the direction of measurement.

As already mentioned, the main conveyor can be inclined transversely to the direction of conveyance, in particular towards the lateral wall, so that a compression of the packaged materials towards the lateral wall is facilitated. It is accordingly advantageous if the main conveyor has a main conveyor unit with a conveyor element moving in the main direction of conveyance, on which the packaged materials are transported, and the alignment of the main conveyor is such that the conveyor element is inclined towards the lateral wall at an angle of inclination >3° to the horizontal. The packaged materials can slide towards the lateral wall on the conveyor element driven by the force of gravity, so that it is compressed there and a space opposite on the main conveyor is freed up.

The invention is additionally directed to a device for conveying packaged materials for combining multiple separate streams of packaged materials into a main stream. The device for conveying packaged materials expediently comprises a main conveyor, which has a conveyor element, a conveyor drive for driving the conveyor element in a main direction of conveyance and at least one lateral wall, which laterally delimits a main stream. Furthermore the device for conveying packaged materials can comprise multiple feed conveyors, which in each case have a conveyor element for conveying the corresponding stream of packaged materials in a feed direction and a conveyor drive to drive the conveyor element in the feed direction. This is expediently arranged transversely to the main direction of conveyance. To facilitate a disruption-free combination of multiple streams of packaged materials it is proposed that according to the invention the main conveyor is arranged relative to the lateral wall in such a way that because of the alignment of the main conveyor relative to the lateral wall, packaged materials from the main stream are guided towards the latter. The device for conveying packaged materials expediently serves to perform the inventive method.

In one advantageous embodiment of the invention the main conveyor is aligned in such a way that the lateral wall lies at an angle to the main direction of conveyance. In particular a conveyor width of the conveyor element of the main conveyor is hereby narrowed in the main direction of conveyance. By means of the alignment of the main conveyor the lateral wall can project into the main stream. The narrowing advantageously takes place towards an outlet of the next feed conveyor downstream. The angle between lateral wall and main direction of conveyance expediently amounts to between 1° and 20°.

In order to prevent jamming of packaged goods directly at the junction of a feed conveyor with the main conveyor it is beneficial if the narrowing through the angled lateral wall is less in the region of the junction than downstream after the junction. In this respect it is expedient if the lateral wall has one section in the main direction of conveyance and a second downstream section, which forms the angle to the main direction of conveyance. In the area of the junction it is possible to dispense with the narrowing, which only occurs downstream. In this respect the section in the main direction of conveyance is expediently located opposite the outlet of one of the feed conveyors.

Between two outlets of two feed conveyors it can in turn be advantageous if the lateral wall initially forms a sharp narrowing and then the narrowing lessens, for example in order to avoid wedging of foil packaging between conveyor element and lateral wall, or as the case may be to release this again. In this respect it is advantageous if the lateral wall comprises a section which forms an angle between 1° and 10° to the main direction of conveyance, and the lateral wall upstream has a second section, which is aligned at a greater angle to the main direction of conveyance. Both areas expediently lie at least partially between the outlets of two feed conveyors on the main conveyor and/or in the region of one outlet, wherein the areas are to be regarded as areas in the main direction of conveyance which also includes areas of the main conveyor opposite an outlet.

The main conveyor routed past multiple outlets of multiple feed conveyors can have an equally wide conveyor element alongside the outlets. Although a relatively simple construction of the main conveyor is hereby enabled, as a result of an angle of the lateral wall to the main direction of conveyance a relatively large amount of conveyor element space outside the lateral wall is however forfeited, upon which conveyance does not take place and which is thus bypassed by the main stream. In order to be able to produce a more compact system it is advantageous if the main conveyor has at least two conveyor units, which are arranged offset relative to each other transversely to the main direction of conveyance. The offsetting is expediently present on both sides, that is each conveyor unit projects over the other on one side.

The combination of multiple streams of packaged materials into a main stream gives rise to a technical challenge if the sum of the widths of the feed conveyor is greater than the width of the main conveyor, so that the width of the individual feeds exceeds the width of the joint outlet capacity, in particular by more than 30%. Or—in order also to include possibly different speeds of conveyance—if the total conveyor surface fed by the individual feed conveyors per unit of time exceeds the conveyor surface cleared over the same time by the main conveyor, in particular by more than 30%.

This challenge can be somewhat ameliorated if the main conveyor has at least two conveyor units, and the conveyor unit arranged downstream in the main direction of conveyance is wider than the conveyor unit located upstream. An outlet of a feed conveyor can lie between the conveyor units.

The description of advantageous embodiments of the invention provided so far includes numerous features which are reproduced in the individual subsidiary claims in part combined into multiple examples. These features can however expediently also be viewed individually and combined into sensible further combinations. In particular these features can be combined in each case individually and in any desired appropriate combination both with the inventive method and with the inventive device according to the independent claims. Also, method features should thus be regarded as objectively formulated as properties of the corresponding device unit and vice versa.

The above-described properties, features and advantages of this invention, and the manner in which they are achieved, will be more clearly and plainly comprehensible in conjunction with the following description of the exemplary embodiments, which will be explained in greater detail in conjunction with the drawings. The exemplary embodiments serve to explain the invention and do not limit the invention, either to the combination of features specified therein, or with respect to functional features. In addition, suitable features of any exemplary embodiment can also be explicitly viewed in isolation, removed from an exemplary embodiment, integrated into another exemplary embodiment for its augmentation and/or combined with any one of the claims, in which:

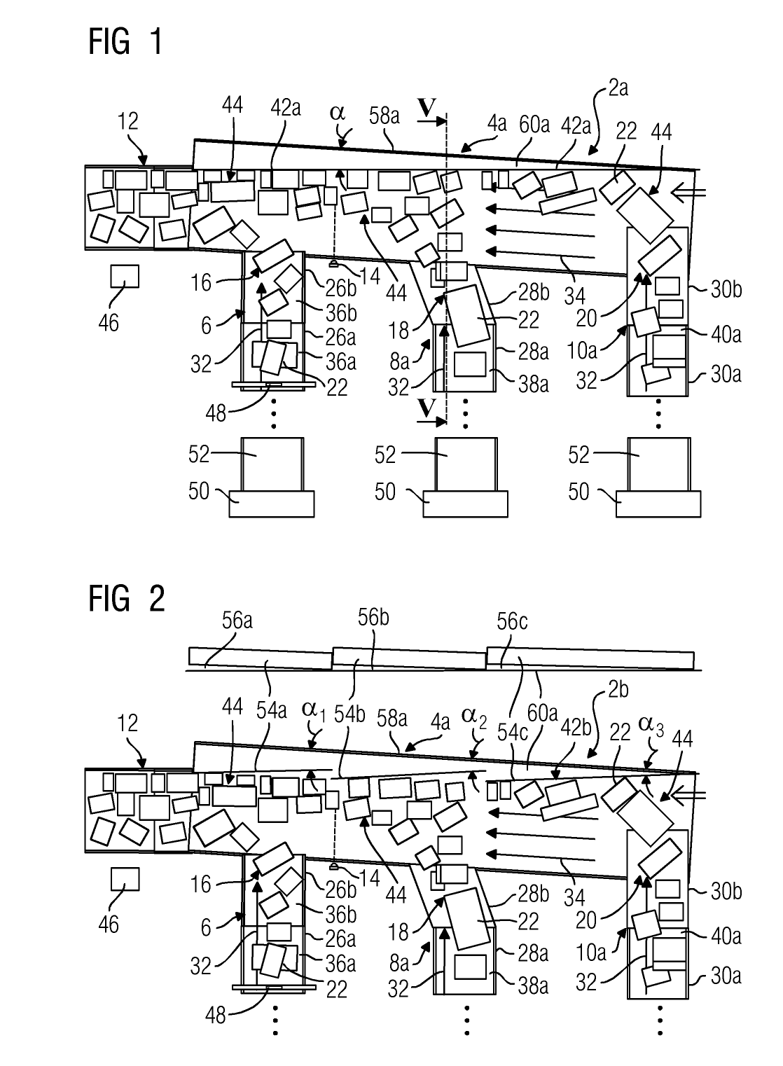

FIG. 1 shows a schematic representation of a device for conveying packaged materials from above, with three feed conveyors and a main conveyor arranged transversely to these,

FIG. 2 shows the device for conveying packaged materials from FIG. 1 with a multi-part lateral wall, whose sections are in each case offset relative to each other,

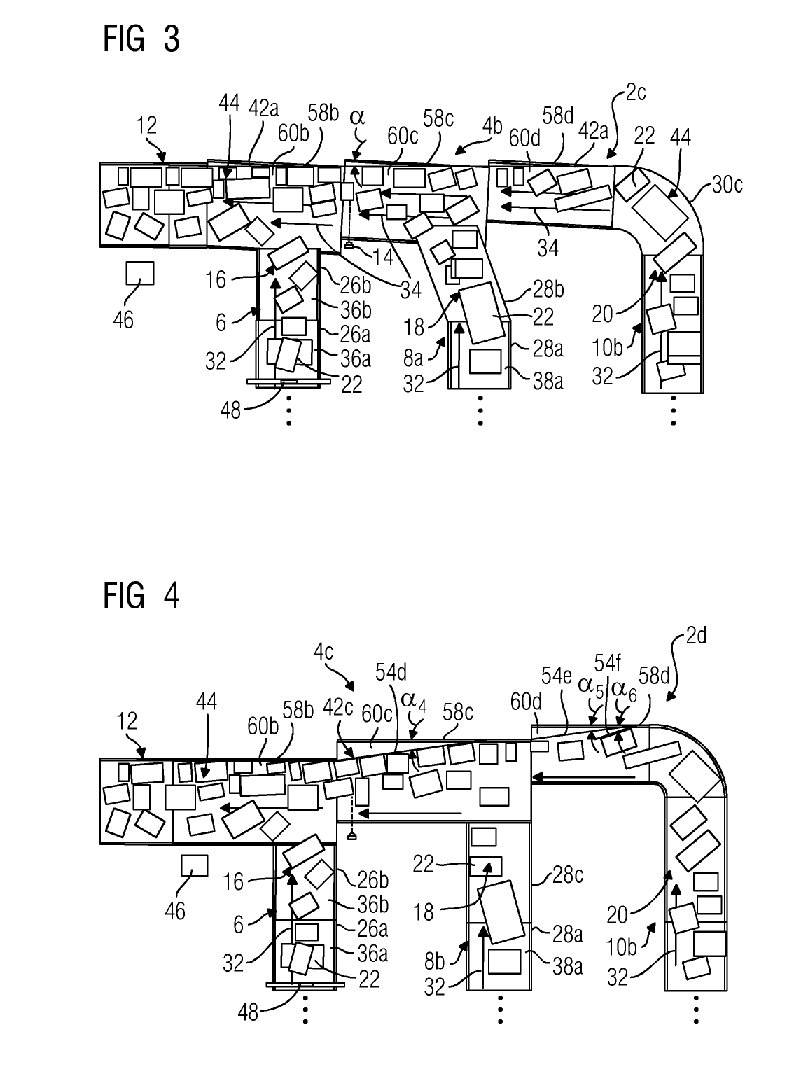

FIG. 3 shows a further device for conveying packaged materials with a main conveyor, which has three conveyor units in each case arranged offset relative to each other,

FIG. 4 shows a further device for conveying packaged materials with a main conveyor with conveyor units arranged offset relative to each other, whose side walls have zones which are not at an angle to the main direction of conveyance and

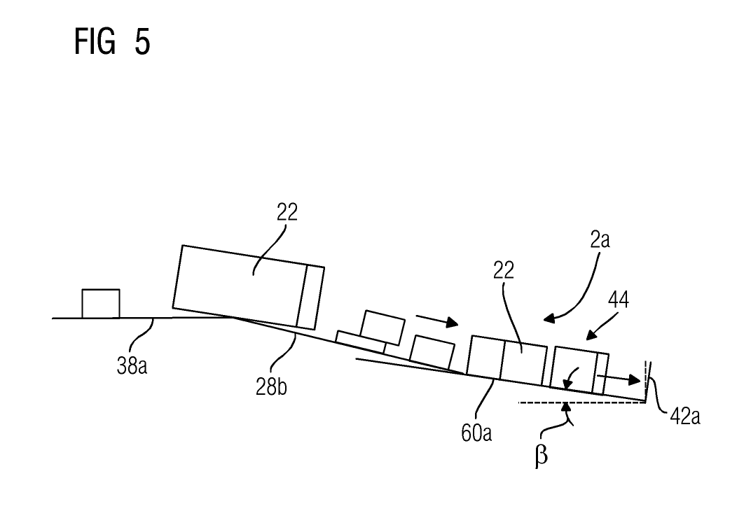

FIG. 5 shows a lateral section through the central feed conveyor and the main conveyor from FIG. 1 with a conveyor element of the main conveyor inclined towards the lateral wall.

FIG. 1 shows a device for conveying packaged materials 2a with a main conveyor 4a with a conveyor element 60a in the form of a conveyor belt and three feed conveyors 6, 8a, 10a. Immediately downstream of the main conveyor 4a is connected a discharge conveyor 12. The main conveyor 4a is equipped with a sensor 14, which is a laser distance measurer for measuring the distance from a sensor output in the direction of measurement, represented in FIG. 1 by a dashed line, to a next object which the measuring beam of the sensor 14 encounters in the direction of measurement.

On the three feed conveyors 6, 8a, 10a a stream of packaged materials 16, 18, 20 is in each case transported in the direction of the main conveyor 4a and onto the latter. The streams of packaged materials 16, 18, 20 comprise in each case a multiplicity of packaged materials 22, which are postal or courier parcels in a parcel center. The individual packaged materials 22 lie in an inhomogeneous or uneven manner in the streams of packaged materials 16, 18, 20 or on the feed conveyors 6, 8a, 10a, specifically both in terms of their alignment within the space and in their distance from each other, as well as their lateral position on the feed conveyors 6, 8a, 10a. In addition, individual items of packaged materials 22 lie one on top of the other. In their size, character, shape, weight and material too, the items of packaged materials 22 are inhomogeneous or different to each other, wherein external packaging made of cardboard and foil alike are present, wherein depending on the embodiment of the packaged materials 22 the foil packaging encloses hard objects, so that the packaged materials are of fixed shape and essentially unchangeable, with soft packaged materials 22 in foil packaging also present, so that the entire packaged materials are soft, flexible and deformable, such as for example clothing or other items shrink-wrapped in foil.

Each of the feed conveyors 6, 8a, 10a has one or multiple conveyor units 26a, 26b, 28a, 28b, 30a, 30b, which convey the respective stream of packaged materials 16, 18, 20 in a feed direction 32. The feed direction 32 is aligned at an angle of 87° to a main direction of conveyance 34, in which packaged materials 22 are transported on the main conveyor 4a. The conveyor units 26a, 26b, 28a, 30a in each case have at least one conveyor element 36a, 36b, 38a, 40a. The conveyor elements 36a, 36b, 38a, 40a can be belt elements, roller conveyors, chutes or a combination thereof. In the exemplary embodiment shown they in each case have a circulating element, for example a conveyor belt, a multiplicity of belt conveyors or the like, which moves in the corresponding direction of conveyance on the upper surface, on which the packaged materials 22 lie on the conveyor element 36a, 36b, 38a, 40a. The conveyor units 28b and 30b are chutes inclined towards the main conveyor 4a, upon which the packaged materials 22 slide downwards onto the main conveyor 4a. With the aid of the force of gravity they thus arrive on the conveyor element 60a of the main conveyor 4a and slide upon this some distance further in the direction of a lateral wall 42a, which laterally delimits the main stream 44 of the packaged materials 22 on the main conveyor 4a.

The feed direction 32 is determined by the movement of the conveyor elements 36a, 36b, 38a, 40a, e.g. conveyor belts, of the conveyor units 26a, 26b, 28a, 30a, which move in the feed direction 32. The main direction of conveyance 34 is determined by the conveyor element 60a, which moves in the main direction of conveyance 34. Packaged materials 22 on the conveyor elements 5, 36a, 36b, 38a, 40a are moved by means of their movement in the corresponding direction of conveyance.

Each of the feed conveyors 6, 8a, 10a is connected to a truck unloading station 50 via unloading apparatus 52, for example a telescopic unloader. The connection can be a direct connection or a connection via further conveyors, as indicated in each case by the three dots in FIG. 1. During operation the packaged materials 22 are unloaded from the truck, for example manually, placed on the unloading apparatus 52, which expediently reaches into the load-space of the truck. From the unloading apparatus 52 the packaged materials 22 are conveyed onto the corresponding feed conveyor 6, 8a, 10a.

The representations of the arrangements of the individual conveyor units 26a-30b are shown in FIG. 1 merely by way of example. The feed conveyors 6, 8a, 10a can also of course have a single conveyor unit only, or more than two conveyor units, which are arranged at different horizontal and/or vertical angles to each other. It is likewise possible that upstream of the first feed conveyor 10a a further feeder, for example for manual input or return feed of packaged materials to the main conveyor 4a is present, as indicated in FIG. 1 by means of a thick arrow on the right-hand side.

The conveyor widths of the feed conveyors 6, 8a, 10a amount in each case to 100 cm. The conveyor width of the main conveyor 4a diminishes in the direction of conveyance, that is downstream, and starts at around 200 cm and at the narrowest point is 150 cm. The narrowest point is at the junction with the discharge conveyor 12, which likewise has this conveyor width. The conveyor width of the main conveyor 4a is to be regarded as running from the lateral wall 42a to the oppositely located belt end of the conveyor element 60a.

The lateral wall 42a is arranged obliquely to the main direction of conveyance 34, specifically at an angle of 3°. The lateral wall 42a thus projects from the side lying opposite to the outlets of the feed conveyors 6, 8a, 10a into the main stream 44. As a result of its angled alignment, lateral wall 42a pushes outlying items of packaged materials 22—relative to the main direction of conveyance 34—in the direction of the outlets of the downstream feed conveyor 6, 8a, so that they slide in this direction over the conveyor element 60a. The conveyor element 60a of the main conveyor 4a thus runs under the lateral wall 42a, wherein the portion of the conveyor element 60a on the sides of the lateral wall 42a facing away from the main stream 44 increases downstream, in the exemplary embodiment from FIG. 1 continuously, in particular over the entire length of the main conveyor 4a.

The main conveyor 4a extends in length over all outlets of the feed conveyors 6, 8a, 10a, which convey their stream of packaged materials 16, 18, 20 onto the main conveyor 4a. In general terms, a main conveyor can be defined as a conveyor system which runs alongside the outlets of at least three, in particular of all feed conveyors, which convey their stream of packaged materials onto the main conveyor. Downstream of the last feed conveyor or the furthest downstream, the main conveyor can merge into a discharge conveyor, as represented by way of example in FIG. 1 on the basis of the main conveyor 4a and discharge conveyor 12. The direction of conveyance of the discharge conveyor 12 is in each case expediently at an angle to the main direction of conveyance 34, and is in particular parallel to the lateral wall 42, and if this is to be divided into multiple sections, parallel to the last section, that is the section located furthest downstream, of the lateral wall 42. Upstream, the main conveyor 4a starts upstream of the feed conveyor lying farthest upstream 10a. The upstream-located start and downstream-located end of the main conveyor 4a lie expediently at a distance of less than 3 meters upstream of the topmost feed conveyor 10a or downstream of the lowest feed conveyor 6.

Depending on the embodiment of the feed conveyors 6, 8a, 10a these can have a transitional conveyor with a direction of conveyance which is at variance to the feed direction 32. This is shown in FIG. 1 by way of example based on the feed conveyor 8a, whose conveyor unit 28b already deflects the direction of conveyance of the stream of packaged materials 18 some distance further in the direction of the main stream 44, or in the main direction of conveyance 34. As a result of this the packages sliding in do not meet the existing stream of packaged materials at an obtuse angle. Aside from the fact that the direction of conveyance of the conveyor unit 28b in FIG. 1 too is still to be viewed as transverse to the main direction of conveyance 34, a larger deflection too is possible within the framework of the invention, if this does not exceed a length of for example 3 meters. The aim of the transverse arrangement of the main direction of conveyance 34 and feed direction 32 is the compact arrangement of the device for conveying packaged materials 2a, so that the streams of packaged materials 16, 18, 20 are not brought together in a parallel manner such as for example in the case of a highway entrance ramp.

During operation of the device for conveying packaged materials 2a the packaged materials 22 in the main stream 44 are moved in the main direction of conveyance 34 and thus moved towards the lateral wall 42a at an acute angle, which is the angle α between the lateral wall 42a and the main direction of conveyance 34. A portion of the packaged materials 22 strikes the lateral wall 42a and by means of its lateral alignment relative to the main direction of conveyance 34 is moved towards other packaged materials 22 moved in the main direction of conveyance 34. The main stream 44 is hereby compressed, so that gaps between the packaged materials 22 in the region of the lateral wall 42a are closed. Additionally, packaged materials 22 located obliquely to the main direction of conveyance 34 are turned during the course of its transport on the main conveyor 4a by the lateral wall 42a as a result of the friction with the lateral wall 42a, until they are aligned parallel to the lateral wall 42a and slide along with a flat face on the lateral wall 42a. Also by these means utilization, that is the filling level, of the conveyor surface of the conveyor element 60a of the main conveyor 4a is increased. By means of the compression and evening-out of the alignment of the packaged materials 22 in the main stream 44 parallel to the lateral wall 42a, space is created for next feeding-in of the subsequent stream of packaged materials from the next feed conveyor 6, 8a downstream.

During guidance of the packaged materials 22 along the lateral wall 42a, they slide with a component of movement transverse to the main direction of conveyance 34 over the main conveyor 4a or its conveyor element 60a. Here, a severe mechanical stress on the underside of the packaged materials 22 should be avoided, in particular tipping of the packaged materials 22 away from the lateral wall 42a into the main stream 44. In order to achieve this, the conveyor element 60a of the main conveyor 4a, which by way of example is a band conveyor, is provided with a conveyor belt with a low coefficient of friction, so that packaged materials 22 located thereupon can be easily shifted and turned parallel to the conveyor surface of the main conveyor 4a, without the danger of damage to the packaged materials 22. As a result of the low coefficient of friction, a transverse sliding of the packaged materials 22 from the sloping surfaces of the conveyor units 28b, 30b onto the main conveyor 4a towards the lateral wall 42a is facilitated, so that the packaged materials 22 slide to the lateral wall 42a under their own speed, if no other packaged materials 22 blocks the path thereto.

The speeds of conveyance of the feed conveyors 6, 8a, 10a and of the main conveyor 4a are regulated by a control unit 46 and can vary, wherein a discharge rate of the main conveyor 4a should be greater than the feed-in rate of all feed conveyors 6, 8a, 10a together. It is likewise possible that the speeds of conveyance of the feed conveyor 6, 8a, 10a have a fixed relationship to each other—independently of a higher-level regulation by a control unit 46, in particular the speeds of conveyance are identical, likewise the speed of discharge of the discharge conveyor 12, which can be identical to or higher than the speed of conveyance of the main conveyor 4a and of the feed conveyors 6, 8a, 10a.

While as a result of the structure and the arrangement the feed conveyors 8a, 10a in the arrangement according to FIG. 1 continuously feed their stream of packaged materials 18, 20 onto the main conveyor 4a, a feed controller is present, which is embodied by the control unit 46 to feed in the stream of packaged materials 16 from the feed conveyor 6 located further downstream. This reads the data from the sensor 14, which determines a free stretch of the main conveyor 4a opposite the lateral wall 42a on the basis of a repeated measurement of the stretch to the next packaged materials 22 encountered by the measuring beam of the sensor 14. The control unit 46 determines a free area on the conveyor element 60a, on the side opposite the lateral wall 42a from the free stretches.

As can be seen from FIG. 1, just on one half of the available width of the main stream 44 or of the conveyor surface of the main conveyor 4a in the region of the sensor 14 opposite the lateral wall 42a is free. This conveyor surface is sufficient for feeding in of the stream of packaged materials 16 from the feed conveyor 6, so that the latter feeds its stream of packaged materials 16 into the main stream 44. If the free conveyor surface is too limited, the control unit 14 reduces the speed of conveyance of the feed conveyor 6, in the most extreme case to a standstill, so that the feeding of the stream of packaged materials 16 into the main stream 44 is reduced. Overfilling and a resultant disruption of the flow of the main stream 44 and possible damage to the packaged materials 22 can hereby be avoided. The monitoring sensor 14 is a distance sensor, in particular a laser distance sensor, which measures the currently available free space at the outlet of the feed conveyor 6.

It can occur that insufficient free space is available for the feeding-in of a stream of packaged materials 16 from a feed conveyor 6, for which reason the feed-in must be reduced or even halted. On the other hand it can happen that the stream of packaged materials 16 on the feed conveyor 6 comes to a halt, for example because a truck connected to the feed conveyor 6 has been emptied. In this case interruption or deceleration of the speed of conveyance of the feed conveyor 6 is not necessary. In particular if only the downstream portion of the feed conveyor 6 is unoccupied or little occupied by packaged materials 22 and an upstream section is heavily occupied, reducing the speed of conveyance has the result that an operative cannot unload his truck due to the overfilling of the feed conveyor 6, or can continue to do so only slowly. A restriction of the feeding speed of the feed conveyor 6 is not necessary due to the low occupancy level of the feed conveyor 6 downstream before outlet in the main conveyor 4a.

In order in such a situation not to disrupt the emptying of a truck or the like, the device for conveying packaged materials 2a comprises an occupancy sensor 48, which is attached over the feed conveyor 6 or its conveyor element 60a. This supplies its data to the control unit 46, which determines the occupancy of the conveyor surface of the feed conveyor 6 under the occupancy sensor 48 from the data. From this, the distance to the outlet of the feed conveyor 6 and the current speed of conveyance of the feed conveyor 6, the feed-in area is calculated which is occupied by packaged materials 22 from the stream of packaged materials 16 from the feed conveyor 6 during feeding-in. This occupied area is compared with the free surface area measured with the sensor 14 or determined by the control unit 46 and the speed of conveyance of the feed conveyor 6 controlled on the basis of this comparison.

The arrangement and the number of sensors 14, 48 present depend on the number of feed conveyors present, their widths, the minimum conveyor width of the main conveyor 4a, in particular at their transition to the discharge conveyor 12 and the speeds of conveyance of the feed conveyor 6, 8a, 10a and of the main conveyor 4a. A single sensor 14 or one sensor in each case can be arranged upstream of such feed conveyors 6, 8a, further upstream of which a further feed conveyor 10a is arranged.

FIG. 2 shows a device for conveying packaged materials 2b, which is largely constructed in the same way as that from FIG. 1. The description that follows is limited essentially to the differences to the exemplary embodiment from FIG. 1, to which reference is made regarding features and functions which remain the same. In order not to have to reiterate on multiple occasions what has already been described, all features of preceding exemplary embodiments are generally incorporated in a respective following exemplary embodiment, without being described anew, unless features are described as differences from the preceding exemplary embodiments. In addition, components remaining essentially the same are identified with the same reference characters. In addition for the purposes of simpler comprehension the same components in different exemplary embodiments are additionally designated with the same reference numerals and different reference letters, wherein they can be identical to each other or with minor differences, for example in dimensions, position and/or function.

In the exemplary embodiment represented in FIG. 2 the lateral wall 42b is divided into multiple sections 54a, 54b, 54c. These are all at least predominantly arranged over the main conveyor 4a, and arranged in succession in the main direction of conveyance 34 and transversely thereto. The angle α₁ of the section 54a to the main direction of conveyance 34 is 5°, the angle α₂ of the section 54b is 7° and the angle α₃ of the section 54c to the main direction of conveyance 34 is again 5°.

With this arrangement the wedging of soft packages, for example foil packages, in a gap between the conveyor element 60a of the main conveyor 4a and the sections 54a-c can be counteracted. While in the case of the lateral wall 42a in FIG. 1 the danger exists that a wedged package is dragged along under it over the entire length of the lateral wall 42a and thus the corresponding packaged materials 22 are drawn ever deeper into the gap, the length of the sections 54a-c is less, so that a stretch over which such dragging takes place is shorter. At the end of the corresponding section 54a-c the wedged packaged materials are released and can now freely contact the next section 54a,b downstream.

In order further to reduce the danger of wedging, a vertically widening gap 56a, 56b, 56c is in each case additionally created downstream between the sections 54a-c and the conveyor element 60a. This is represented in schematic form in the top section of the illustration from FIG. 2. Between itself and the conveyor element 60a each of the sections 54a-c has a gap 56a-c, the vertical height of which increases downstream. In the case of a movement downstream in the main direction of conveyance 34 or in the direction of the corresponding section 54a-c of the lateral wall 42b, packaged materials 22 wedged in this gap 56a-c are thus released again, or the wedging remains so loose that damage to the packaged materials 22 is avoided. The enlargement is for example at least double, in particular at least three times the minimum height of a gap 56a-c.

The different angularities of the sections 54a-c to the main direction of conveyance 34 are on one hand attributable to their length. The longer a section 54a-c is, the smaller is its angle to the main direction of conveyance 34. The different angle is further attributable to the mean pressure of the packaged materials against the corresponding section 54a-c. The greater the pressure of the packaged materials, the smaller is the angle to the main direction of conveyance 34. Thus while the uppermost section 54c is relatively long and therefore relatively shallowly angled, the middle section 54b is shorter and correspondingly steeply angled. Although by contrast the lowest section 54a is once again short, it is subject to a high pressure of packaged materials, for which reason its angle is smaller than in the case of the section 54b located upstream.

In the case of the exemplary embodiment of a device for conveying packaged materials 2c shown in FIG. 3 its main conveyor 4b is divided into three sections with in each case one conveyor unit 58b, 58c, 58d. Thus while the main conveyor 4a has just a single conveyor unit 58a, the main conveyor 4b from FIG. 3 comprises three conveyor units 58b-58d. With reference to the exemplary embodiment from FIG. 1 the remaining components are the same, wherein however the uppermost feed conveyor 10b has a conveyor unit 30c in the form of a 90° curved conveyor. This is directly connected to the uppermost conveyor unit 58d of the main conveyor 4b.

In the exemplary embodiment from FIG. 3, the lateral wall 42a is once again continuously aligned and at an angle α=3° to the main direction of conveyance 34. It is however likewise readily possible to embody the lateral wall 42a as for example in FIG. 2.

The conveyor units 58b-d are arranged laterally offset relative to each other, wherein a conveyor unit 58c,d located upstream surmounts an immediately adjacent and downstream conveyor unit 58b,c on the side on which the lateral wall 42a is arranged on the main conveyor 4b. On the opposite side the reverse situation applies: here the respective downstream conveyor unit 58b,c laterally surmounts the upstream conveyor unit 58c,d.

In addition the conveyor width of a downstream conveyor unit 58b,c is greater than the conveyor width of the respective upstream conveyor unit 58c,d. In this way the overall width of the conveyor elements 60b-d increases downstream from conveyor unit to conveyor unit 58b-d. However as a result of the angled lateral wall 42a, the usable conveyor width on each of the conveyor units 58b-c or conveyor elements 60b-d within the corresponding unit or of the corresponding element diminishes in the downstream direction. Good compression of the packaged materials 22 in the direction of the lateral wall 42a and an alignment of the packaged materials 22a in the direction of the lateral wall 42a can hereby be achieved.

FIG. 4 shows a further exemplary embodiment of a device for conveying packaged materials 2d with a main conveyor 4d, which are of the same structure as in the case of the device for conveying packaged materials 2c from FIG. 3, except for the feed conveyor 8b, which instead of the chute 28b has a conveyor unit 28c with a band conveyor, in a similar manner to conveyor unit 26b. Additionally, the lateral offset of the conveyor units 58b-d is greater than in the exemplary embodiment from FIG. 3, and the lateral wall 42c too is no longer embodied in continuous form. It comprises two sections 54d, 54e arranged at an acute angle to the main direction of conveyance 34, which upstream and/or downstream abut a lateral wall section, which is aligned parallel to the main direction of conveyance 34. The two sections 54d,e are at an angle α₄=8° and α₅=8° to the main direction of conveyance 34, wherein the two angles α₄, αₛ can also be different.

Arranged in the area of the junction of the conveyor unit 28c is a lateral wall section not at an angle to the main direction of conveyance 34, so that a compression of the main stream 44 can there be dispensed with. Jamming of the packaged materials 22 in the case of a heavy stream of packaged materials 18 from the conveyor unit 28c can hereby be prevented. The same also applies to the outlet of the feed conveyor 6, wherein in the region of the conveyor unit 58b an angled lateral wall section has been completely dispensed with, so that a compression of the main stream 44 does not thereby take place. This can be compensated for by the marked lateral offsetting of the conveyor unit 58b-d relative to each other and by the great angle α₄ of the lateral wall 42c, by means of which the main stream 44 is already sufficiently compressed before the junction of the feed conveyor 6.

A further section 54f of the lateral wall 42c is represented by way of example on the conveyor unit 58d. This has an angle α₆=18° to the main direction of conveyance 34. In addition this section 54f is spring-mounted in a pivotable manner, so that it is pressed against the section 54e by heavy packaged materials 22 and thus assumes its angle α₅. The exerting of a greater pressure on the packaged materials 22 can hereby be reciprocally avoided in the event of a jam forming, as in the case of such pressure the section 54f pivots outwards and frees up a greater conveyor width.

The additional section 54f has the advantage that the main stream 44 in its area can be strongly compressed and the risk of jamming is reduced by means of the pivoting capability and secondly the wedging of soft packages under the lateral wall 42c is counteracted. This is because the section 54f can be kept short by means of the large angle α₅, so that a stretch within which the packaging is wedged in the gap remains short. Additionally, in the case of firm wedging the section 54f additionally springs outwards, so that a further drawing-in of the packaged materials 22 or their packaging into the gap is prevented. In addition the gap increases in size vertically, as explained with reference to the gaps 56a-c in FIG. 2. Jamming can hereby be counteracted and packaged materials which nevertheless find their way under the section 54f can rapidly be released again.

Based on the exemplary embodiment from FIG. 5 there follows a description of another possibility for compression of the main stream 44 towards the lateral wall 42a, which can be used in addition to the lateral wall 42a angled towards the main direction of conveyance 34 or also without an angled lateral wall 42a.

FIG. 5 shows in a schematic manner a section through the device for conveying packaged materials 2a from FIG. 1 along the dashed line V-V from FIG. 1. Shown in schematic form is the conveyor element 38a of the feed conveyor 8a and its conveyor unit 28b embodied as a chute, which discharges onto the conveyor element 60a of the main conveyor 4a. It can be seen that the conveyor element 60a is inclined at an angle β=10° to the horizontal, specifically towards the lateral wall 42a, which is represented as solid lines in FIG. 5. By means of this inclined alignment of the main conveyor 4a relative to the lateral wall 42a the packaged materials 22 from the main stream 44 are guided by the force of gravity in the direction of the lateral wall 42a. They slide over the smooth surface of the conveyor element 60a towards the lateral wall 42a. A compression of the main stream 44 against the lateral wall 42a and an alignment of the packaged materials 22 in the direction the lateral wall 42a can be achieved hereby too.

In the exemplary embodiment shown in FIG. 5 the lateral wall 42a is aligned perpendicularly to the alignment of the conveyor element 60a, in order to provide the generally rectangular packaged materials 22 with a good contact surface. It is of course also possible to align the lateral wall 42a perpendicularly to the horizontal, as represented in FIG. 5 by the dashed line. Independently of the tilting or alignment of the lateral wall 42a, the alignment of the main conveyor 4a relative to the lateral wall 42a embodied as an inclination at an angle β relative to the horizontal can bring about the compression of the main stream 44 on its own or in conjunction with the lateral wall 42a angled to the main direction of conveyance 34. This inclination can be realized in the case of all previously described exemplary embodiments.

Although the invention has been illustrated and described in greater detail by means of the preferred exemplary embodiments, the invention is not limited by the example disclosed, and other variations can be derived by the person skilled in the art, without departing from the protective scope of the invention.

1-15. (canceled)

16. A method for combining multiple separate streams of packaged materials into a main stream, the method comprising the following steps:
conveying each of the separate streams of packaged materials on a respective feed conveyor;
combining each of the separate streams of packaged materials with the main stream in a region of a feed opening of each respective feed conveyor;
further transporting each of the separate streams of packaged materials onto a main conveyor in the main stream;
using at least one lateral wall to laterally delimit the main stream; and
guiding the packaged materials in a region between two feed openings of two feed conveyors from the main stream towards the at least one lateral wall and then along the at least one lateral wall, by aligning the main conveyor relative to the at least one lateral wall.

17. The method according to claim 16, which further comprises:
moving the main stream on the main conveyor in a main direction of conveyance at an angle relative to the at least one lateral wall; and
guiding the packaged materials from the main stream towards the at least one lateral wall and then along the at least one lateral wall by the movement in the main direction of conveyance.

18. The method according to claim 16, which further comprises:
placing the at least one lateral wall between two feed openings of two of the feed conveyors and opposite the feed openings relative to the main stream; and
using the at least one lateral wall to push the packaged materials in a direction of a feed opening of a next downstream feed conveyor.

19. The method according to claim 16, which further comprises loading postal or courier consignments as the packaged materials from a truck unloading station onto a telescopic unloader, and using the unloader to convey the consignments onto the feed conveyor feeding the consignments into the main stream.

20. The method according to claim 16, which further comprises spring-mounting the at least one lateral wall and pivoting the at least one lateral wall due to packaged materials striking the at least one lateral wall, for diminishing an angle between the at least one lateral wall and a main direction of conveyance of the main stream on the main conveyor.

21. The method according to claim 20, which further comprises bringing the at least one lateral wall to rest against a stop in a position describing an angle between 1° and 10° relative to the main direction of conveyance.

22. The method according to claim 16, which further comprises:
providing at least one of the feed conveyors with a junction aligned obliquely downwards in a direction of the stream of the at least one feed conveyor; and
using the force of gravity to aid in sliding the packaged materials upon the junction in a direction of the main conveyor and transversely to a main direction of conveyance on the main conveyor in a direction of the at least one lateral wall.

23. The method according to claim 16, which further comprises:
using an occupancy sensor disposed on the main conveyor to measure a stretch of the main conveyor free from packaged materials; and
using a control unit to control feeding of a stream of packaged materials from a feed conveyor onto the main conveyor depending on a value derived from the stretch.

24. The method according to claim 16, which further comprises:
providing the main conveyor with a conveyor unit having a conveyor element moving in a main direction of conveyance for transporting the packaged materials on the conveyor element;
carrying out the alignment of the main conveyor to incline the conveyor element towards the at least one lateral wall at an angle of inclination >3° to the horizontal; and
using the force of gravity to slide the packaged materials on the conveyor element towards the at least one lateral wall.

25. A device for conveying packaged materials by combining multiple separate streams of the packaged materials into a main stream, the device comprising:
a multiplicity of feed conveyors each having a respective conveyor element for conveying a corresponding stream of packaged materials in a feed direction; and
a main conveyor downstream of said feed conveyors, said main conveyor having a conveyor element for transporting the packaged materials in a main direction of conveyance and said main conveyor having at least one lateral wall laterally delimiting said main stream;
said main conveyor being aligned relative to said lateral wall to cause the packaged materials from said main stream to be guided towards said lateral wall.

26. The device for conveying packaged materials according to claim 10, wherein:
said alignment of said main conveyor places said lateral wall at an angle of between 1° and 20° relative to said main direction of conveyance; and
said conveyor element of said main conveyor has a conveyor width narrowing in said main direction of conveyance.

27. The device for conveying packaged materials according to claim 25, wherein said main conveyor has at least two conveyor units (58b, 58c, 58d) being mutually offset transversely to said main direction of conveyance.

28. The device for conveying packaged materials according to claim 25, wherein said main conveyor has at least two conveyor units including a conveyor unit disposed downstream and a conveyor unit disposed upstream in said main direction of conveyance, said conveyor unit disposed downstream being wider than said conveyor unit disposed upstream.

29. The device for conveying packaged materials according to claim 25, wherein said lateral wall is disposed at least partially over said conveyor element of said main conveyor forming a gap between said lateral wall and said conveyor element, said gap becoming vertically larger downstream in said main direction of conveyance.

30. The device for conveying packaged materials according to claim 25, which further comprises an occupancy sensor disposed at said main conveyor for measuring a stretch of said main conveyor being free of packaged materials.
